(19) United States
(12) Patent Application Publication
(10) Pub. No.: US 2024/0413989 A1
(43) Pub. Date: Dec. 12, 2024

(54) METHOD FOR ENCRYPTING A PLAINTEXT

(71) Applicant: MERCEDES-BENZ GROUP AG, Stuttgart (DE)

(72) Inventor: Viktor FRIESEN, Karlsruhe (DE)

(21) Appl. No.: 18/702,543

(22) PCT Filed: Oct. 7, 2022
(86) PCT No.: PCT/EP2022/077966

§ 371 Date: Apr. 18, 2024

(30) Foreign Application Priority Data
Oct. 19, 2021 (DE) 10 2021 005 213.7

(51) Int. Cl. H04L 9/08

(52) U.S. Cl. CPC H04L 9/088

(57) ABSTRACT

The invention relates to a method for encrypting a Plaintext is encrypted using a block cipher E of the block size L_{E} using a symmetric key K. A fingerprint function is used that satisfies the two requirements that from two different bit sequences there is a sufficiently high probability for the application that the results of the application of the fingerprint function to these bit sequences are also different and that a fingerprint inverse function exists for the fingerprint function such that a certain condition always applies.

### BACKGROUND AND SUMMARY OF THE INVENTION

Exemplary embodiments of the invention relate to a method for encrypting a plaintext with a block cipher E of the block size L_{E} using a symmetric key K.

High-frequency sending and receiving of short messages is of great importance in some applications within a vehicle ecosystem, examples of the latter are found, for example, in DE 10 2021 001 095 A1. As outlined in this document, it is often vital to provide these messages with cryptographic integrity protection and/or cryptographic replay protection, without increasing the length of the messages too significantly, wherein, as outlined in the specified publication, only symmetric methods can be considered for this purpose for reasons of energy efficiency. In some cases, however, it can be important to encrypt the entire message, or at least a part thereof, for example the user data, for example in order to protect confidential user data and/or to make it more difficult for a potential attacker to read, interpret, and thus reverse engineer the messages and the protocol used.

Similar considerations as are made for the integrity and the replay protection in DE 10 2021 001 095 A1 also apply to the encryption. In principle, in particular short messages could be encrypted asymmetrically, for example with methods based on RSA. The RSA ciphertext of plaintext is, however, at least as long as the key used for the encryption, and thus for example, 2048 bits when RSA 2048 is used. Thus, an e.g., 20 byte, i.e., 160 bit-long, unencrypted message becomes an at least 2048 bit-long encrypted message to be transmitted, which runs entirely contrary to the need to use short messages. In addition, asymmetric decryption requires a lot of time in comparison with symmetric encryption or decryption. Thus, only symmetric methods can be considered for efficient encryption of short, higher-frequency messages.

Today, primarily block ciphers, e.g., AES, are used for symmetric encryption. The block size of a block cipher E is here denoted by L_{E} or L_E. In the Raw encryption with a block cipher E of the block size L_{E}, an exactly L_{E} bit-long plaintext, a so-called plaintext block, is encrypted into an exactly L_{E} bit-long ciphertext, a so-called ciphertext block, using a symmetric key. Correspondingly, in the Raw decryption with a decryption function D belonging to a block cipher E of the block size L_{E}, an (exactly L_{E} bit-long) ciphertext block is decrypted into an (exactly L_{E} bit-long) plaintext using a symmetric key. In both cases, therefore, exactly one complete block is always processed, inputs having different lengths are not accepted. The E-Raw encryption and the D-Raw decryption are here respectively denoted by E^{RAW} and D^{RAW}. The E-Raw encryption with a symmetric key K is denoted by E^{RAW}_{K}, and the D-Raw decryption with a symmetric key K is denoted by D^{RAW}_{K}.

In an encryption with a block cipher E, a plaintext that is longer than L_{E} bits is divided into blocks corresponding to the cipher block size L_{E}, which are then encrypted individually using a symmetric key. The encryption of the individual plaintext blocks completely independently of one another is called ECB mode (of a block cipher). Unlike the Raw encryption, a cipher operated in the ECB mode can handle inputs of any length. If the last plaintext block is shorter than the block size of the block cipher, a so-called padding is applied, which fills out this last plaintext block in a defined manner. ECB is the simplest operation mode for a block cipher, but it has the disadvantage that when using the same key, the same plaintext blocks are encrypted into the same ciphertext blocks, whereby an attacker could draw conclusions in relation to the corresponding plaintext blocks.

To counteract this ECB mode drawback, more complex operation modes (CBC, CFB, OFB, CTR, etc.) have been developed in which, instead of the direct encryptions of the individual plaintext blocks independently of one another, as in the ECB mode, the encryptions of the individual plaintext blocks are interwoven more or less closely with one another, such that further, usually one-block-long data generated during the encryption of its preceding block is included in the encryption of a next plaintext block in addition to the plaintext block itself and to the key, wherein this data included in the encryption of the next plaintext block can depend on the preceding plaintext block (CBC, CFB), or can be independent thereof (OFB, CTR).

In this manner, roughly speaking, the same plaintext blocks are generally encrypted into the same ciphertext blocks; however, this does not apply to the first plaintext block, because the latter has no preceding block from which it could receive the additional input data. In order to remedy this, one-block-long initialization vectors, which are used as this additional data when encrypting the first block, are generally used. An initialization vector may be used only once, and thus for only one plaintext, otherwise the same ciphertext blocks are generated again for the same plaintext blocks (when the key is the same), and an initialization vector must thus be a nonce (number used only once) when the same key is used. An initialization vector only needs to be novel, and thus a nonce, and it need not be kept secret. Instead, the initialization vector used for the encryption is also required in the decryption, and thus the initialization vector must be known to both the transmitter and the receiver. Because it does not need to be kept secret, it can for example also be transmitted as an explicit, unencrypted part of the message, which is done with TLS, for example. If this is the case, then it must not be transmitted encrypted, because without the initialization vector present as a plaintext block, the receiver cannot decrypt the encrypted message.

The explicit transmission of the initialization vector, in particular as part of short messages, is resource-intensive, however, because an initialization vector is generally one block long, for example 128 bits in AES. If it is known in advance how many messages at most are encrypted with the same key, then a counter can be run on the transmitter's side, which is incremented by one with each new message. From this counter, an initialization vector, which is new due to the counter incrementation which has previously taken place and is generally one block longer, can be generated by the transmitter for each new message, for example via a suitable padding method coordinated between the transmitter and the receiver, using which, or using a cryptographic hash function followed by a sometimes necessary length adjustment, the counter bits are supplemented by further bits, and said initialization vector can be used to encrypt the message. Instead of sending the entire initialization vector with each message, only the counter, i.e., the counter bits representing the counter and which represent the number of the respective message, is sent. The space required in the message can thus be reduced, from e.g., 128 bits to e.g., 32 bits, if the counter is 32 bits long.

It would be particularly space-saving to use an implicit shared initialization vector whereby the transmitter and the receiver first agree on a common start initialization vector and an instruction to generate a new novel initialization vector from the current initialization vector and then generate this next novel initialization vector synchronously for each new message on both sides using the previously agreed instruction. The problem here is that messages can be lost, or arrive in the wrong order, whereby the synchronicity of the initialization vectors used by the transmitter and by the receiver are lost.

Another likewise space-saving way of implicitly synchronizing an initialization vector between the transmitter and the receiver would be to derive the initialization vector from the message itself, which has to be transmitted anyway, in a secure manner, which the transmitter and the receiver could do independently of each other. The problem here is that, on the one hand, the initialization vector must be known to the transmitter before the encryption process, and must thus be able to be derived from the plaintext message, but on the other hand it must be known to the receiver before the decryption process, and must thus be able to be derived from the encrypted message, which (at first glance) is a contradictory requirement.

So-called synthetic initialization vectors (SIV), which are used in specific AEAD methods (“Authenticated Encryption with Associated Data”), i.e., methods that enable both an encryption and an authentication, are characterized in that they generate the initialization vector used for the encryption from the message itself by generating a unique authentication stamp (Tag) from the message, which is then used as an initialization vector when encrypting the message or parts thereof. AEAD variants based on synthetic initialization vectors have been developed for different AEAD operation modes, e.g., for a combination of CMAC and CTR (SIV-AES), for AES-GCM (AES-GCM-SIV) or for CCM (CCM-SIV) (see also DE 10 2019 113 026 A1). However, because the initialization vector, i.e., the authentication stamp generated from the unencrypted message, is also required when decrypting the message, but cannot be immediately derived from the encrypted message by the receiver, it must be sent unencrypted to the receiver together with the encrypted message, whereby no space is saved in the message by using a synthetic initialization vector according to the methods specified above.

In this context, reference can in principle be made to US 2015/0349950 A1.

In WO 2009/013420 A1, an authentication method similar to CBC-MAC and based on block ciphers is defined, which, instead of computing the message authentication code (MAC) only via the message itself, as, for example, in CBC-MAC, computes the message authentication code via the message extended by a prefix containing the hash value of the message.

As specified above, the key drawback of the ECB mode is the fact that the same plaintext is encrypted into the same ciphertext when using the same key. Because this is a problem only in the context of the use of the same key, and the problem is resolved to an extent when a key is changed, a fixed shared symmetric key K is assumed for the rest of the document.

The common requirement that a novel initialization vector should be used for the encryption of each new plaintext is sufficient but not absolutely necessary to remedy the drawback described above, however. Indeed, if it can be ensured that the first block of a plaintext is always novel, then the requirement to use a novel initialization vector in the operation modes (e.g., CBC, CFB) which include the previous block, in particular the previous ciphertext block, when concatenating the blocks can be dispensed with. In particular cases, it is thus sufficient for the combination of the initialization vector and the first plaintext block to be novel for a fixed key. If the first plaintext blocks are always novel, then there is no need to use an initialization vector at all in these particular cases.

If it is desired or necessary, for example for reasons of space, to dispense with an (explicit or implicit) initialization vector that is guaranteed to be novel for each plaintext to be encrypted, then it is advisable to design the format of the plaintexts such that the probability that the first block of a plaintext is always novel is maximized.

Because the probability that the individual plaintexts are “novel”, and thus differ within pairs, is greater than the probability that the first blocks of the respective plaintexts are novel, and thus differ within pairs, it is logical, in order to have the greatest probability of obtaining novel first blocks, to collect the “novelty” of the entire plaintext in the first block, and thus to design the first blocks of the respective plaintexts such that the first blocks of two different plaintexts also always differ.

Depending on the plaintext pair, differences between two plaintexts can arise in different places in the plaintexts, and the “novelty” can thus be distributed over all of the plaintext bit positions. Thus, no plaintext format can generally be found that guarantees maximum probable novel first plaintext blocks by simply rearranging the respective plaintext bits. The “novelty” contained in the plaintexts can be accumulated very effectively, however, by applying a cryptographic hash function HASH to a sequence of particular selected bits, the combination of which may possibly be novel. If a difference in at least one of the bits arises in two bit sequences BF1 and BF2 that belong to two different plaintexts and are used to form the hash value, then the hash values HashTag1:=HASH(BF1) and HashTag2:=HASH(BF2) of the two bit sequences containing this different bit also have a very high probability of differing.

The hash value HashTag:=HASH(BF) computed in this way could now be used directly as an initialization vector, or an initialization vector could be derived therefrom, which would always be new if the plaintext bit sequence BF included in the computation of the hash value were novel. This is the procedure for the synthetic initialization vectors (SIV) described above, for example. The problem in this case is that, as already explained above, the initialization vector must be known to the receiver so that the latter can decrypt the entirely or partially encrypted plaintext. If it is not desired to explicitly transmit the initialization vector unencrypted as part of the plaintext, which is undesirable for space-saving reasons, this would mean that no part of the bit sequence BF, which is used to form the hash value HashTag, may be encrypted, because otherwise the receiver cannot derive the initialization vector used by the transmitter in the encryption from the received partially or completely encrypted plaintext.

Exemplary embodiments of the present invention are directed to an improved method for encrypting a plaintext with a block cipher using a symmetric key K and to provide the mechanisms required for this purpose.

A way is thus first of all needed to encode the entire novelty of a plaintext in the first block of the plaintext, so that any change in the entire plaintext, including the first block, results in a change to the first plaintext block. The method according to the invention for encrypting a preferably at least (u+1) bit-long plaintext with a block cipher E of the block size L_{E} using a symmetric key K according to the invention uses the result of the application of a fingerprint function (FPᵤ) to the concatenation of the complete first u bits of the plaintext, and of selected or of all bits of the remaining plaintext, as a replacement for the combination of an initialization vector and the first u bits of the plaintext. The fingerprint function only needs to satisfy the two requirements that, from two different bit sequences (BF1≠BF2), it follows with a sufficiently high probability for the application—as defined above—that the fingerprints of the two bit sequences are also different (FPᵤ(BF1)≠FPᵤ(BF2)), and that a fingerprint inverse function (FPᵤ⁻¹) exists for the fingerprint function (FPᵤ), such that the following always applies: FPᵤ⁻¹(FPᵤ(BF)∥BF[u+1 . . . L(BF)])=BF[1 . . . u].

In this case, u and L_{E} need not necessarily be the same. A general cipher EGen, which does not require an initialization vector, is used to encrypt the first u bits PB^{u}₁ of the plaintext by applying FPᵤ, as described, to the concatenation of the complete first u bits PB^{u}₁ of the plaintext and of selected or of all of the bits FPInput of the remaining plaintext, and then computing the first block of the ciphertext CB₁ by EGen encryption of the u bit-long result FPᵤ (PB^{u}₁∥FPInput). The character ∥ represents the concatenation of two bit sequences. The following thus results CB₁:=EGen(FP (PB^{u}₁∥FPInput)). In principle, it is not necessary for EGen to be length-preserving, and thus for CB₁ also to be u bits long, even if this will mostly be the case in practice.

The thus generated encryption of the first u bits of the plaintext CB₁ can thus be used as an initialization vector IV:=CB₁ to encrypt parts of the or the total remaining plaintext with the block cipher E, for which purpose any operation mode requiring an initialization vector (IV) can be used.

By applying a fingerprint function FPᵤ before the encryption with EGen, it can be ensured in an advantageous manner that novel plaintexts have a very high probability of also leading to novel inputs for the cipher EGen, which in turn has a very high probability of leading to a novel ciphertext CB₁, and thus to a novel initialization vector IV. For example, in the event that the fingerprint function FP^{Tag,_u, Scramble_u} is used as FPᵤ in the computation of the pseudo-random CB₁, the first u bits of the plaintext PB^{u}₁ (via Scrambleᵤ) and the rest of the plaintext (via Tagᵤ) are included to the same extent, and thus it is ensured that there is a very high probability of the initialization vector IV derived from the first u bits CB₁ encrypted by means of FP^{Tag,_u, Scramble_u} and EGen being novel if the entire output plaintext is also new.

According to a very advantageous embodiment of the solution according to the invention, in order to generate a u-bit-long fingerprint of a bit sequence BF of which the length is greater than u, it is provided that the fingerprint is implemented as a result of the function FPᵤ(BF) or FP^{Tag_u, Scramble_u} (BF), wherein the latter is defined as Scrambleᵤ (BF[1 . . . u])⊕Tagᵤ(BF[u+1 . . . L(BF)]), where Tagᵤ is a function that computes, for bit sequences (BF) of any length, a value of the length u having a sufficiently high probability of being unique for the application, e.g., a pseudo-random value, where Scrambleᵤ is an invertible function which maps bit sequences (BF) of the length u to bit sequences (BF) of the length u, and where ⊕ stands for a bitwise XOR operation of two bit sequences (BF) of the same length.

In order to encode the novelty of an entire plaintext in the first u bits of the plaintext and to be able to use this fact for the encryption, a function FPᵤ (“Fingerprint”) is sought for a natural number u>0, which determines a bit sequence FPᵤ(BF) of the length u for a bit sequence BF where L(BF)>u (L(BF) in this document denotes the bit length of a bit sequence BF) in such a way that:
from BF1≠BF2, FPᵤ(BF1)≠FPᵤ(BF2) follows with a sufficiently high probability for the application,
an FP inverse function FPᵤ⁻¹ exists for FPᵤ, such that
FPᵤ⁻¹(FPᵤ(BF)∥BF[u+1 . . . L(BF)])=BF[1 . . . u] always applies,
where for a bit sequence BF and natural numbers i, j, where 1≤i≤j≤L(BF), BF[i . . . j] denotes the partial sequence of BF consisting of the bits i to j, and thus for example BF=BF[1 . . . L(BF)] applies, and | denotes the concatenation of two bit or byte sequences.

The phrase “having a sufficiently high probability for the application” should be understood to mean a probability which, on the basis, among other factors, of the size of u, is sufficiently certain, in the case of the specified application for two bit sequences BF1, BF2, where BF1≠BF2, to lead to the result FPᵤ(BF1)≠FPᵤ(BF2). In principle, an exact value cannot be specified here because the function Tag involves the mapping of a (u+x)-long bit sequence BF to a u-long bit sequence, so that when there are two different bit sequences BF1, BF2, their tags differ “as far as possible”, i.e., “where possible” Tag(BF1)≠Tag(BF2) follows from BF1≠BF2.

In practice, however, no such function Tag exists ensuring this 100% for all BF1, BF2, because Tag(BF) is always u bits long and thus shorter than “most” bit sequences BF. If, for example, u=2 is selected, then there are only four different tags: 00, 01, 10, 11.

Thus, with any five different bit sequences BF1 . . . BF5, there would be a 100% probability of at least one collision, and i.e., a duplication of at least two of the five tags Tag(BF1) . . . Tag(BF5). Furthermore, where u=2, and for two randomly selected bit sequences BF1, BF2, the probability of a collision, and thus of Tag(BF1)=Tag(BF2), would be at least 25%. Thus, the “performance” (i.e. the quality or the probability of (BF1≠BF2⇒Tag(BF1)≠Tag(BF2)) of a function Tagᵤ is at most as good as the size of u.

On the other hand, there are collision-resistant cryptographic hash functions which, used as Tagᵤ and provided that u is sufficiently large, guarantee this desired property (BF1≠BF2⇒Tag(BF1)≠Tag(BF2)) with “almost 100%”. However, they cannot guarantee it 100% either, see considerations above. However, the probability that, in the case of use of collision-resistant cryptographic hash functions, (BF1≠BF2⇒Tag(BF1)≠Tag(BF2)) applies as a tag is considered as so high that the security of many cryptographic mechanisms seen as secure is based on this. The principle having the probability mentioned is, for example, also the basis of legally sound digital signatures etc.

It can be the case that a hash function delivers a value (hashtag) for example of 256 bits, as e.g., SHA-256 does. However, the function Tag according to the invention wants to use a value of u=20. The first 20 bits of the hashtag delivered by SHA-256 could then be used as Tag. There would thus be a performance of “almost 100%” delivered by SHA-256, which, however, is then significantly reduced by the use of u=20. A logical selection of u, and also of the function Tag, now depends on the respective individual case or use case. If, for example, u=128 is selected, and the first 128 bits of the value delivered by SHA-256 are selected as Tag, this is considered, according to current knowledge, to be “on the safe side” for all applications. However, there can certainly be cases in which, for example, u=80 bits is also completely sufficient in practice for a particular application, and thus guarantees a sufficiently high probability for FPᵤ(BF1)+FPᵤ(BF2) for the application when BF1≠BF2. If the value of the probability had to be quantified, then obviously in practice, in almost all cases, a u>=80 would be selected, thus achieving, with a suitable Tag, a probability of significantly above (1-2²⁰).

In this advantageous embodiment of the solution according to the invention, it is proposed to use the general form FPᵤ(BF) or FP^{Tag_u, Scramble_u}: Scrambleᵤ (BF[1 . . . u])⊕Tagᵤ(BF[u+1 . . . L(BF)]) for a function FPᵤ, where:
Tagᵤ is a function that computes, for bit sequences of any length, a value of the length u that has a sufficiently high probability of being unique or pseudo-random for the application, for example a cryptographic hash function, of which the hash value is adapted securely to the length u as required, and thus, for example, by using the last u bits of the hash value as Tagᵤ(BF) in the event of a hash value which is too long, or by stretching said hash value to the length u, for example using a cryptographic key stretching method, in the event of a hash value which is too short.
   By suitably selecting Tagᵤ, the weak-weak and the weak-strong FP collision resistances can be achieved, and the non-invertibility, the strong-weak FP collision resistance and the strong-strong FP collision resistance can be made possible, as is explained later.
Scrambleᵤ is an invertible function that maps bit sequences of the length u to bit sequences of the length u, for example a length-preserving encryption (with the associated decryption as an inverse function).
   By suitably selecting Scrambleᵤ, when the Tagᵤ function is simultaneously suitably selected, the properties of non-invertibility, the strong-weak FP collision resistance and the strong-strong FP collision resistance, which are only related to the attacker as explained later, can be achieved.
⊕ denotes the bitwise XOR operation of two bit sequences of the same length.

The FP inverse function of FP^{Tag_u, Scramble_u} is then given by (FP^{Tag_u, Scramble_u})⁻¹(BF)=Scrambleᵤ⁻¹(BF[1 . . . u]⊕Tagᵤ(BF[u+1 . . . L(BF)]). If a function FPᵤ has the described general form, then it is uniquely determined by the two functions Tagᵤ and Scrambleᵤ.

Due to this fingerprint function FP^{Tag_u, Scramble_u}, it is possible to dispense with the use of an initialization vector when symmetrically encrypting novel plaintexts without significant losses in security, and to encrypt the plaintext completely.

According to a very advantageous development, it can be provided that a cryptographic hash function is used as the function Tagᵤ, of which the hash value is adapted to the length u in a secure manner.

Furthermore, in a favorable development of the method, it can also be provided according to the invention that the function Tagᵤ has the property of non-invertibility and/or is collision-resistant in at least one way.

The non-invertibility makes it practically impossible for an attacker to find a bit sequence BF2 for a given bit sequence BF1 such that BF1=FPᵤ(BF2)∥BF1[u+1 . . . L(BF)]. In the context of the present description, an attacker should be understood to mean someone who, unlike a “non-attacker”, does not know the (secret) keys sometimes used when defining or determining FPᵤ.

Four different kinds of collision resistance are conceivable, wherein they are respectively denoted as a two-tuple in the form of (r1, r2)∈{strong, weak}×{strong, weak}, where the first element r1 here denotes the actual FP collision resistance, and the meaning of the second element r2 is based on the collision resistance terms known from cryptographic hash functions.
[weak-weak FP collision resistance] It is practically impossible to find a bit sequence BF2 for a given bit sequence BF1 such that BF1[1 . . . u]=BF2[1 . . . u], BF1[u+1 . . . L(BF1)] #BF2[u+1 . . . L(BF2)] and FPᵤ(BF1)=FPᵤ(BF2).
[strong-weak FP collision resistance] It is practically impossible for an attacker to find a bit sequence BF2 for a given bit sequence BF1 such that BF1≠BF2 and FPᵤ(BF1)=FPᵤ(BF2).
[weak-strong FP collision resistance] It is practically impossible to find two bit sequences BF1 and BF2 such that BF1[1 . . . u]=BF2[1 . . . u], BF1[u+1 . . . L(BF1)] #BF2[u+1 . . . L(BF2)] and FPᵤ(BF1)=FPᵤ(BF2).
[strong-strong FP collision resistance] It is practically impossible for an attacker to find two bit sequences BF1 and BF2 such that BF1≠BF2 and FPᵤ (BF1)=FPᵤ (BF2).

It is clear that the non-invertibility and all kinds of collision resistances can only be achieved when u is sufficiently large.

A very favorable development of the method can further provide that a keyless or key-dependent cryptographic hash function HASH (K_H) is used as the function Tagᵤ, wherein K_H denotes the key on which HASH sometimes depends, and the brackets show that HASH may or may not depend on K_H.

Additionally, a very favorable embodiment of the method can also provide that an identity function or a length-preserving encryption function is used as the function Scrambleᵤ, wherein in the event of encryption, the appropriate decryption function for the encryption is used as an inverse function. According to a very advantageous development of the latter, it can further be provided that for a block cipher E having the block size L_{E}=u and an L_{E} bit-long symmetric key K_S, the E_Raw encryption with K_S, i.e. E^{RAW}_{K_S}, is used as the function Scrambleᵤ.

In an advantageous embodiment, it is further proposed to use the encryption of the first u bits of the plaintext CB₁ thus generated as an initialization vector IV:=CB₁ to encrypt parts of or the total remaining plaintext with the block cipher E, wherein for this purpose any operation mode requiring an initialization vector can be used, wherein beforehand, depending on the length of CB₁ and depending on the selected operation mode, the initialization vector IV might be adapted to the length of the initialization vector required by the respective operation mode in a secure manner, e.g., if L(CB₁)=L_{E}, the IV is shortened if it is used as a nonce of the CTR operation mode.

According to a further advantageous embodiment of the invention, it is proposed to use an FP function in the manner described above, i.e., FP^{Tag_u, Scramble_u}, when a plaintext is encrypted with a block cipher E of the block size L_{E} using a symmetric key K, wherein it can generally be the case that u≠L_{E}, and to use a general cipher EGen, which does not require an initialization vector, by applying FP^{Tag,_u, Scramble_u} to the concatenation of the total first u bits PB^{u}₁ of the plaintext (“plaintext block”) and to selected or to all bits FPInput of the remaining plaintext, and then by computing the first block of the ciphertext CB₁ by EGen encryption of the u bits-long result FP^{Tag_u, Scramble_u} (PB^{u}₁∥FPInput), i.e. CB₁:=EGen(FP^{Tag_u, Scramble_u} (PB^{u}₁∥FPInput)).

Because it is a goal of the method to generate messages that are as short as possible, it is proposed to select a length-preserving cipher as the general cipher EGen, such that, for example, L(CB₁)=u always applies. The ciphertext CB₁ is then labelled CB^{u}₁.

When selecting the operation mode for encrypting the remaining plaintext, the extent to which the actual novelty of the initialization vector thus computed is ensured should be estimated. If the novelty of the initialization vector is ensured, for example by including a complete counter, which does not repeat, in the bit sequence BF, then each operation mode which requires a novel initialization vector can be used securely. If, however, the novelty of the initialization vector is only ensured depending on the novelty of the plaintext itself, but this is not ensured, for example the novelty of the plaintext is probable but not certain, then higher risks are associated with the use, for example, of OFB or CTR, but also CFB, and CBC should for example preferably be used.

In many cases, the use of an initialization vector can thus be dispensed with when encrypting the first block without or without significant losses in security. By using the novel encrypted first block as an initialization vector for novel plaintexts to encrypt the remaining blocks, an operation mode requiring an initialization vector, e.g., CBC, CFB, OFB, CTR, etc., can thus be used to encrypt the remaining blocks.

According to an advantageous development of the method according to the invention, the length of the initialization vector IV is adapted depending on the selected operation mode and/or depending on the length of CB₁.

An alternative solution to the method according to the invention provides the encryption of a preferably at least (u+1) bit-long plaintext with a block cipher E of the block size L_{E} using a symmetric key K, wherein a fingerprint function FP^{Tag_u, Scramble_u} (BF):=Scrambleᵤ (BF[1 . . . u])⊕Tagᵤ(BF[u+1 . . . L(BF)]) is used as a fingerprint function (FPᵤ). In this case, Tagᵤ is a function which computes, for bit sequences BF of any length, a value of the length u that has a sufficiently high probability of being unique for the intended application, where Scrambleᵤ is an invertible function mapping bit sequences (BF) of the length u to bit sequences (BF) of the length u, and where @ stands for a bitwise XOR operation of two bit sequences (BF) of the same length. In order to ensure the novelty of the bit sequence included in the Tagᵤ function of the fingerprint function FP^{Tag_u, Scramble_u}, a secure, key-dependent hash function HASH_{K_H} is used as the basis for the Tagu^{K_H} function of a fingerprint function FPu^{K_H} for each new message, the additional encryption of the first u bits of the plaintext by means of EGen is dispensed with and instead the FPᵤ^{K_H} fingerprint is used directly as the encryption of the first u bits CB^{u}₁.

A fingerprint function in the form FP^{Tag_u, Scramble_u}, defined by FP^{Tag_u, Scramble_u} (BF):=Scrambleᵤ (BF[1 . . . u])⊕Tagᵤ(BF[u+1 . . . L(BF)]), is thus used, where Tagᵤ is implemented by a secure, key-dependent hash function HASH_{K_H}, of which the output length is suitably adapted to u, where Scrambleᵤ is an invertible function which maps bit sequences (BF) of the length u to bit sequences (BF) of the length u, and where ⊕ stands for a bitwise XOR operation of two bit sequences (BF) of the same length, where u and L_{E} need not necessarily be the same, in that the fingerprint function FP^{Tag_u, Scramble_u} is applied to the concatenation of the total first u bits PB^{u}₁ of the plaintext, and of selected or of all bits FPInput of the remaining plaintext, and if the novelty of the bit sequence FPInput included in the Tagᵤ function of the fingerprint function FP^{Tag_u, Scramble_u} is ensured for each new message, the FP^{Tag_u, Scramble_u} fingerprint, i.e. CB₁:=FP^{Tag_u, Scramble_u} (PB^{u}₁∥FPInput), is used directly as the encryption of the first u bits CB^{u}₁, and the encryption of the first u bits of the plaintext CB₁ thus generated is used as the initialization vector IV:=CB₁ for the encryption of parts of or all of the remaining plaintext with the block cipher E, wherein for this purpose any operation mode requiring an initialization vector (IV) is used.

Further advantageous embodiments and different forms of the method according to the invention result from the further sub-claims dependent on claims 1 and 12 and become clear from the exemplary embodiments, which are explained in more detail in the following with reference to the Figures.

### BRIEF DESCRIPTION OF THE DRAWING FIGURES

Here:

FIG. 1 shows a schematic depiction of the Fingerprint (FP) function including its inverse;

FIG. 2 shows the functioning of the encryption and decryption using the two general FP functions as independent components;

FIG. 3 shows the functioning of the encryption and decryption using the FP functions FP^{Tag,_u, Scramble_u} and (FP^{Tag,_u, Scramble_u})⁻¹ broken down into their components;

FIG. 4 shows the functioning of the two FP functions FPᵤ^{HASH(K_H), ID} (for u=L_{E}) and _{FP}HASH(K_H), E-K_S in summary;

FIG. 5 shows the functioning of the encryption and decryption (in the event of FPu^{HASH(K_H)}, ID for u=L_{E} and FP^{HASH(K_H), E-K_S}) once using the two FP functions as independent components;

FIG. 6 shows the functioning of the encryption and decryption (in the event of FPᵤ^{HASH(K_H), ID} for u=L_{E} and FP^{HASH(K_H), E-K_S}) once using the two FP functions as FP functions broken down into their components;

FIG. 7 shows how an alternative encryption and decryption method works;

FIG. 8 shows how an alternative encryption and decryption method works; and

FIG. 9 shows a schematic depiction of the method of DE 10 2021 001 095 A1 as an addition to the methods according to the invention.

### DETAILED DESCRIPTION

A first relevant aspect for the method for encryption is the method for generating a u bit-long fingerprint (FPᵤ) of a bit sequence. The latter serves to encode the novelty of an entire plaintext in the first u bits of the plaintext, and to be able to use this fact for the encryption, a function FPᵤ (“Fingerprint”) is thus sought for a natural number u>0, which determines a bit sequence FPᵤ(BF) of the length u for a bit sequence BF where L(BF)>u(L(BF) in this document denotes the bit length of a bit sequence BF) in such a way that:
FPᵤ(BF1)≠FPᵤ(BF2) follows with a very high probability from BF1 ¥ BF2,
an FP inverse function FPᵤ⁻¹ exists for FPᵤ, such that FPᵤ⁻¹(FPᵤ (BF)∥BF[u+1 . . . L(BF)])=BF[1 . . . u] always applies, where for a bit sequence BF and natural numbers i, j, where 1≤i≤j≤L(BF), BF[i . . . j] denotes the partial sequence of BF consisting of the bits i to j, and thus for example BF=BF[1 . . . L(BF)] applies, and ∥ denotes the concatenation of two bit or byte sequences,
optionally, the condition of non-invertibility is fulfilled, and it is thus practically impossible for an attacker to find a bit sequence BF2 for a given bit sequence BF1 such that BF1=FPᵤ(BF2)∥BF1[u+1 . . . L(BF)],
optionally, FPᵤ is also collision-resistant.

It is proposed to use the general form FPᵤ(BF)=Scrambleᵤ(BF[1 . . . u])⊕Tagᵤ(BF[u+1 . . . L(BF)]) for a function FPᵤ, where
Tagᵤ is a function which computes, for bit sequences of any length, a value of the length u that has a very high probability of being unique or pseudo-random, for example a cryptographic hash function, of which the hash value is adapted securely to the length u as required, and thus, for example, by using the last u bits of the hash value as Tagu(BF) in the event of a hash value which is too long, or by stretching said hash value to the length u, for example using a cryptographic key stretching method, in the event of a hash value which is too short.
   By suitably selecting Tagᵤ, the weak-weak and the weak-strong FP collision resistances can be achieved, and the non-invertibility, the strong-weak FP collision resistance and the strong-strong FP collision resistance can be made possible.
Scrambleᵤ is an invertible function mapping bit sequences of the length u to bit sequences of the length u, for example a length-preserving encryption (with the associated decryption as an inverse function).
   By suitably selecting Scrambleᵤ, when the Tagᵤ function is simultaneously suitably selected, the properties of non-invertibility, the strong-weak FP collision resistance and the strong-strong FP collision resistance, which are only related to the attacker, can be achieved.
⊕ denotes the bitwise XOR operation of two bit sequences of the same length.

The FP inverse function of FPᵤ is then given by FPᵤ⁻¹(BF)=Scrambleᵤ⁻¹(BF[1 . . . u]⊕Tagᵤ(BF[u+1 . . . L(BF)]). If a function FPᵤ has the described general form, then it is uniquely determined by the two functions Tagᵤ and Scrambleᵤ. The FP function described by these two functions is here denoted by FP^{Tag_u, Scramble_u}. This can be seen in the depiction of FIG. 1 in a process diagram.

For a general cipher EGen (encryption), the associated decryption function DGen (decryption), and a bit sequence BF, EGen (BF) denotes the result of the encryption of BF with EGen, and DGen (BF) denotes the decryption of BF with DGen, and thus DGen(EGen(BF))=BF always applies.

For a block cipher E (encryption) with the associated decryption function D (decryption), and an operation mode OM (“Operation Mode”) requiring an initialization vector, E^{OM}_{K}(IV, PT) denotes the result of the E encryption of the plaintext PT (“Plaintext”) of a length matching E^{OM} with the key K in the operation mode OM using the initialization vector IV, and D^{OM}_{K}(IV, CT) denotes the result of the D decryption of the ciphertext CT of a length matching EOM with the key K in the operation mode OM using the initialization vector IV.

The proposed encryption method contains several components of a message MP as input and encrypts parts thereof with the key K. The following description of the encryption method consists of a description of the components that the method uses, a description of the input formats and a description of the actual method, which generates a completely or partially encrypted message M_{C} from the components of the plaintext message M_{P} using the components.

Components of the encryption system comprise:
A general, length-preserving, secure cipher EGen
A block cipher E of the block size L_{E}
E^{OM}, a block cipher E operated in the operation mode OM requiring an initialization vector of the length L_{OM-IV}
A fingerprint function FPᵤ, which is shortened to FP in the following.
An optional post-processing function OM-NB adapted to the operation mode MO, which generates a pseudo-random OM initialization vector in a secure manner from a bit sequence of the length u, for example by first symmetrically encrypting the bit sequence, and then adapting the length to Lom-Iv using established methods.

Input formats:
A symmetric key K of the length L_{E}
A message M_{P} consisting of a plaintext part PT to be encrypted and a following associated part AD (“Associated Data”), i.e., M_{P}=PT∥AD, wherein L (PT)>u, i.e., PT is longer than u. The associated part AD is not encrypted, but it contributes to the formation of the OM initialization vector, and thus to its novelty.
   The plaintext part PT consists in turn of three parts, PB^{u}₁, PT^{OM}₁ and PT^{OM}₂,
   i.e. PT=PB^{u}₁∥PT^{OM}₁∥PT^{OM}₂, where PB^{u}₁ and PT^{OM}₂ contribute to the formation of the initialization vector, and PT^{OM}₁ does not contribute to the formation of the OM initialization vector, where
      L(PB^{u}₁)=u, PB^{u}₁ is thus exactly u bits long and
      PT^{OM}₁∥PT^{OM}₂ has a length matching E^{OM}, such that PT^{OM}₁∥PT^{OM}₂ can be encrypted by E^{OM}.
Two implicit bit sequences that can contribute to the increase of the probability of the novelty of the OM initialization vector, and are equally known to the transmitter and to the receiver, and thus are not part of the message M_{P}, are for example a counter known to both sides, or the hash value or the encryption of such a counter.
   Bit sequence ImpIAD (“implicit additional data”) of any length, which serves as an additional input for the fingerprint function FP.
      If the use of ImpIAD is to be dispensed with, then the empty bit sequence can be selected as ImpIAD.
   Bit sequence ImpIᵤ of the length u, with which the FP fingerprint is XOR linked.
      If the use of ImpIᵤ is to be dispensed with, then the bit sequence consisting of u 0 bits can be selected as ImpIᵤ (the 0 bit is the neutral element with regard to XOR).

Encryption E^{FP,EGen, OM, OM-NB} with a key K, i.e., E^{FP,EGen, OM, OM-NB}_{K}:
Input:
   1. PB^{u}₁, PT^{OM}₁, PT^{OM}₂, AD where
      M_{P}=PB^{u}₁∥PT^{OM}₁∥PT^{OM}₂∥AD
   2. ImpIAD, ImpIᵤ
Determining the encrypted parts of M_{C}:
   1. FPB:=FP(PB^{u}₁∥PT^{OM}₂∥AD∥ImpIAD)
   2. CB^{u}₁:=EGen(FPB⊕ImpIᵤ)
   3. OM-IV:=OM-NB (CB^{u}₁)
   4. CT^{OM}:=E^{OM} (OM_{K}-IV, PT^{OM}₁∥PT^{OM}₂)
Output:
   1. CB^{u}₁, CT^{OM}, then
      M_{C}:=CB^{u}₁∥CT^{OM}∥AD applies.
In summary, it is proposed to determine the encryption Mc of a plaintext message
M_{P}=PB^{u}₁∥PT^{OM}₁∥PT^{OM}₂∥AD consisting of PB^{u}₁, PT^{OM}₁, PT^{OM}₂, AD as follows:
   E^{FP, EGen, OM, OM-NB}_{K}(PB^{u}₁, PT^{OM}₁, PT^{OM}₂, AD, ImpIAD, ImpIᵤ):=CB^{u}₁∥E^{OM}_{K} (OM-NB(CB^{u}₁), PT^{OM}₁∥PT^{OM}₂)
   where CB^{u}₁:=EGen(FP(PB^{u}₁∥PT^{OM}₂∥AD∥ImpIAD)⊕ImpIᵤ)

Components of the decryption system comprise:
The decryption function DGen belonging to the generally secure, length-preserving cipher EGen
The decryption function D belonging to the block cipher E
The decryption function D^{OM} belonging to E^{OM}
FP, OM-NB, as in the encryption, FP⁻¹ the inverse function to FP

Input formats:
A symmetric key K, as in the encryption
A message M_{C}′ consisting of a ciphertext CT′, and a following, non-encrypted associated part AD′, i.e. M_{C}′=CT′∥AD′, where L(CT′)>u.
   The ciphertext part CT′ consists in turn of two parts, an encrypted first block CB^{u}′ and a following ciphertext CT^{OM}′, i.e. CT′=CB^{u}₁′∥CT^{OM}′ and M_{C}′=CB^{u}₁′∥CT^{OM}′∥AD′, where
      L(CB^{u}₁′)=u, CB^{u}₁′ is thus exactly u bits long and
      CT^{OM}′ has a length matching D^{OM}, so that CT^{OM}′ can be decrypted by D^{OM}.
ImpIAD′, ImpIᵤ′, as in the encryption

Decryption D^{FP, DGen, OM, OM-NB} with a key K, i.e. D^{FP, DGen, OM, OM-NB}_{K}:
Input:
   1. CB^{u}₁′, CT^{OM}′, AD′ where
      M_{C}′=CB^{u}₁′∥CT^{OM}′∥AD′
   2. L_{PT1}, length of the plaintext part PT^{OM}₁
   3. ImpIAD′, ImpIᵤ′
Determining the decrypted parts of M_{P}′:
   1. OM-IV′:=OM-NB(CB^{u}₁′)
   2. PT^{OM}′:=D^{OM}_{K}(OM-IV′, CT^{OM}′)
   3. PT^{OM}₁′:=PT^{OM}′[1 . . . L_{PT1}] and PT^{OM}₂′:=PT^{OM}′[L_{PT1}+1 . . . L(PT^{OM′})]
   4. PB^{u}₁′:=FP⁻¹ ((DGen(CB^{u}₁′)⊕ImpIᵤ′)∥PT^{OM}₂′∥AD∥ImpIAD′)
Output:
   1. PB^{u}₁′, PT^{OM}′, then
      M_{P}′:=PB^{u}₁′∥PT^{OM}′∥AD′ applies

In summary, it is proposed to define the decryption M_{P}′ of a ciphertext message M_{C}′=CB^{u}₁′∥CT^{OM}′∥AD′ consisting of CB^{u}₁′, CT^{OM}′, AD′ as follows:

$${D}^{FP , DGen , OM , OM - {NB}_{K}} ( {{CB}_{1}^{u}}^{′} , {{CT}^{OM}}^{′} {AD}^{′} , {L}_{PT 1} , {Impl}_{u}^{′} ) := {FP}^{- 1} ( ( D C e n ( C {{B}_{1}^{u}}^{′} ) ⊕ {{Impl}_{u}}^{′} ) ‖ {{PT}^{OM}}^{′} [ {L}_{PT 1} + 1 .. L ( P {{T}^{OM}}^{′} ) ] ‖ AD ‖ {ImpIAD}^{′} ) ‖ {{PT}^{OM}}^{′} where {{PT}^{OM}}^{′} := {D}^{O {M}_{K}} ( OM ‐ NB ( {{CB}_{1}^{u}}^{′} ) , C {{T}^{OM}}^{′} )$$

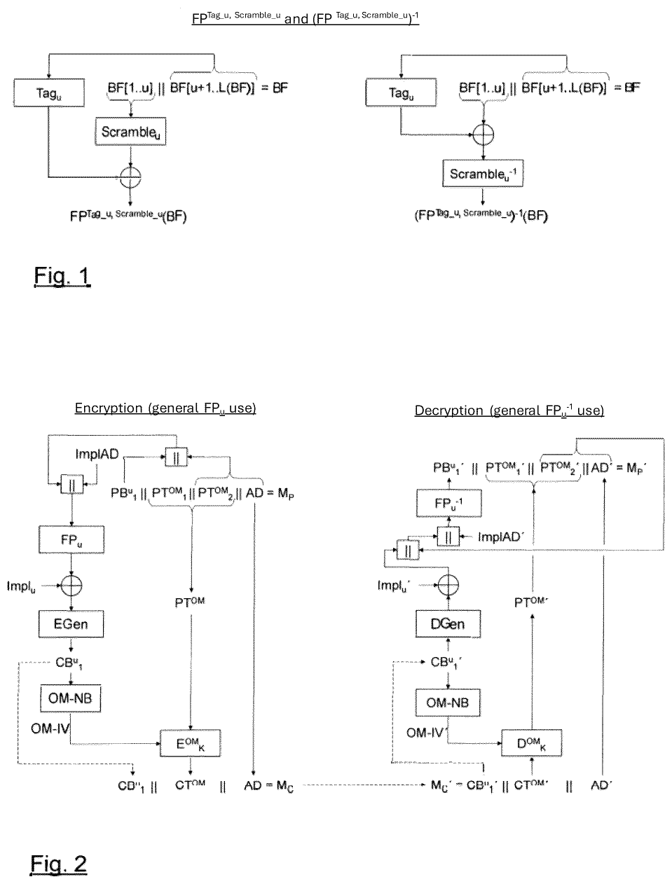

FIG. 2 and FIG. 3 both show the functioning of the encryption and decryption once using the two general FP functions as independent components, and once with FP functions FP^{Tag,_u, Scramble_u} and (FP^{Tag,_u, Scramble_u})⁻¹ broken down into their components.

For the FP partial function Tagᵤ, a keyless, e.g., SHA-256 or SHA-512, or a key-dependent, e.g., HMAC, CBC-MAC or CMAC cryptographic hash function can be used as a basis. The use of a keyless cryptographic hash function has the advantage that the one-way property, and where applicable the weak or strong collision resistance of the cryptographic hash function apply regardless of whether a key is known, whereas in the case of a key-dependent cryptographic hash function, these properties are not always given if the key used is known. The use of a key-dependent hash function has the advantage that a potential attacker cannot compute a hash value of a bit sequence known to them without knowledge of the key. HMAC or key derivation functions (KDF) combine the two approaches, and thus combine the advantages of the two classes of hash functions. A keyless cryptographic hash function is here denoted by HASH, a key-dependent cryptographic hash function using the key K_H is denoted by HASH_{K_H}, either a keyless cryptographic hash function or a key-dependent cryptographic hash function using the key K_H is denoted by HASH_{(K_H)}. The label Tagᵤ^{K_H} is used if Tagᵤ uses a hash function HASH_{K_H} dependent on a key K_H as a basis, FPᵤ^{K_H} indicates that the associated Tagᵤ function uses a hash function HASH_{K_H} dependent on a key K_H as a basis. If FPᵤ uses a cryptographic hash function fulfilling the condition of weak (strong) hash collision resistance as a basis for Tagᵤ, then FPᵤ has the property of weak-weak (weak-strong) FP collision resistance. In addition, by using a cryptographic hash function as a basis for Tagᵤ, the prerequisite for the non-invertibility, the strong-weak or the strong-strong FP collision resistance of FPᵤ is created.

If HASH_{(K_H)} generates a hash value of a length deviating from u, then it is proposed to adapt the hash value generated by HASH_{(K_H)} to u using a length adaptation function LAᵤ, where LAᵤ is a function which generates a pseudo-random bit sequence of the length u from a pseudo-random bit sequence PZBF of any length using methods known from cryptography, for example by using the last u bits of PZBF as LAᵤ(PZBF) in the event of an output bit sequence PZBF which is too long or, if a bit sequence PZBF is too short, by for example stretching said bit sequence to the length u using a key stretching method.

It is further proposed to use the identity function ID, which leaves the bit sequence unaltered, for the function Scrambleᵤ, which is effectively equivalent to dispensing with a Scrambleᵤ function. The inverse function to the identity function is the identity function ID itself. This particularly simple variant of Scrambleᵤ leads in turn to a simple FPᵤ function, which can advantageously be used if, for example, the non-invertibility of the FPᵤ function and the strong-weak or strong-strong FP collision resistances are not required.

For a keyless or key-dependent cryptographic hash function HASH_{(K_H)}, FPᵤ^{HASH(K_H), ID} denotes the FPᵤ function using HASH_{(K_H)} as a Tagᵤ function and the identity function ID as a Scrambleᵤ function, wherein the application of a corresponding length adaptation function LAᵤ is adopted. FPᵤ^{HASH(K_H), ID} thus forms the HASH_{(K_H)} hash value of the bits lying outside of the first plaintext block of the plaintext, and adds this to the unaltered first u bits of the plaintext block after a length adaptation by LAᵤ by ⊕. FPᵤ^{HASH(K_H), ID} is weak-weak or weak-strong FP collision-resistant, if HASH_{(K_H)} is in turn weak or strong collision resistant.

However, there can be configurations in which the non-invertibility of the FPᵤ function and/or its strong-weak and/or strong-strong FP collision resistance are advantageous. For example, in such a case, it is proposed to use a length-preserving encryption for the function Scrambleᵤ. Note that this encryption need not necessarily be strong, because the result of Scrambleᵤ is not disclosed, and is instead further encrypted with EGen, but the strengths of the properties of the corresponding FPᵤ function relating to the attacker depend directly on the strength of the Scrambleᵤ encryption used.

If u=L_{E} for a block cipher E, the E^{RAW} encryption can advantageously be implemented as length-preserving encryption that cannot be computed or inverted by the attacker and requires no initialization vector. If u is equal to the block size of a symmetric cipher E, and thus if u=L_{E}, then it is proposed to use the E-Raw encryption, and thus Scrambleᵤ:=E^{RAW}_{K_S}, as the function Scrambleᵤ for a symmetric key K_S. The inverse function to E^{RAW}_{K_S} is the associated decryption function D^{RAW}_{K_S}. By using an E-Raw encryption as Scrambleᵤ, while simultaneously using a cryptographic hash function HASH_{(K_H)} as Tagᵤ, the properties of the non-invertibility of the FPᵤ function, the strong-weak FP collision resistance or the strong-strong FP collision resistance, which are only related to the attacker, are also achieved.

For a keyless or key-dependent cryptographic hash function HASH_{(K_H)} and a block cipher E with a matching symmetric key K_S, FP^{HASH(K_H), E-K_S} denotes the FPᵤ function using HASH_{(K_H)} as a Tagᵤ function and E^{RAW}_{K_S} as a Scrambleᵤ function, wherein u=L_{E}, and the application of a corresponding length adaptation function LA_{L_E} is adopted. FP^{HASH(K_H),E-K_S} thus forms the HASH_{(K_H)} hash value of the bits of the plaintext lying outside of the first plaintext block and adds this to the E-Raw encryption of the first plaintext block after a length adaptation by LA_{L_E} by ⊕. FP^{HASH(K_H), E-K_S} has the property of non-invertibility, and is strong-weak or strong-strong FP collision-resistant if HASH_{(K_H)} is weak or strong collision resistant.

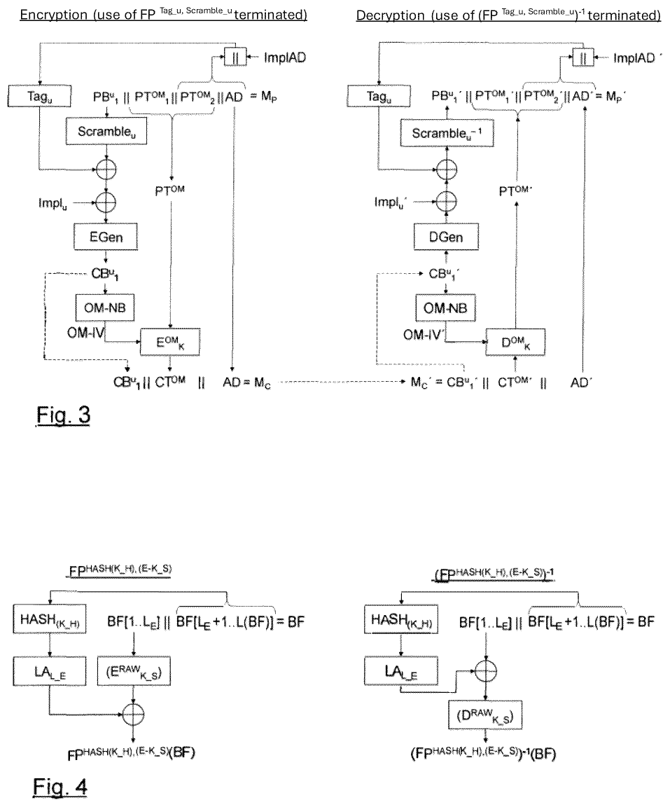

FIG. 4 shows, in summary, the functioning of the two FP functions FPᵤ^{HASH(K_H), ID} (for u=L_{E}) and FP^{HASH(K_H), E-K_S}, where FP^{HASH(K_H), (E-K_S)} stands for both of these FP functions, (E^{RAW}_{K_S}) denotes the identity function ID or the E-Raw encryption E^{RAW}_{K_S}, and (D^{RAW}_{K_S}) denotes the identity function ID or the E-Raw decryption D^{RAW}_{K_S}.

In the encryption method described above, e.g. in the case of E^{FP, EGen, OM, OM-NB}_{K}, FPᵤ^{HASH(K_H), ID} or FP^{HASH(K_H), E-K_S} can be used as FP functions.

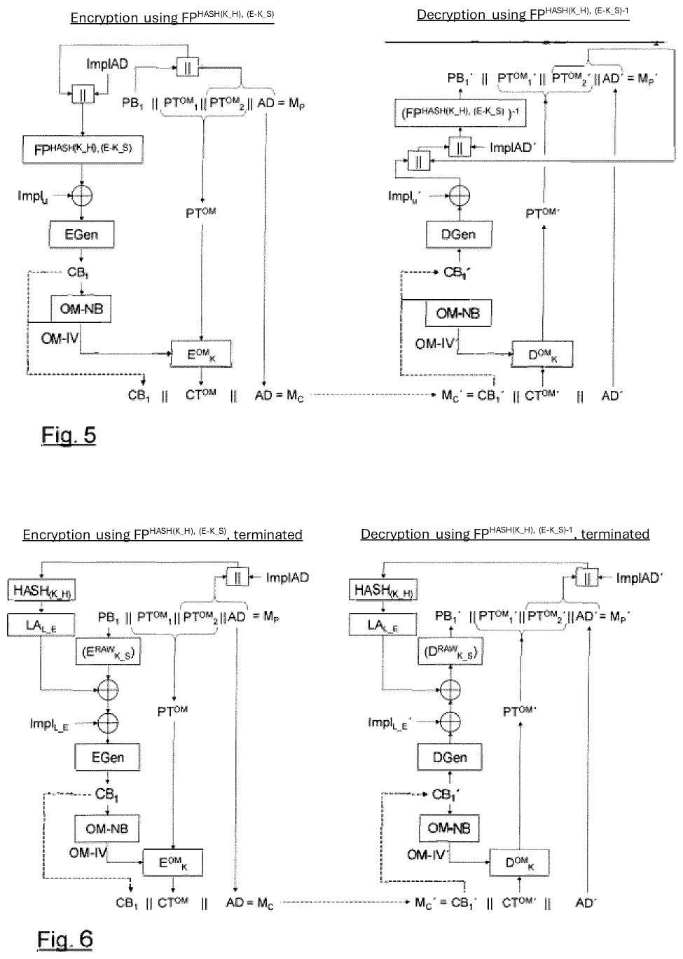

FIG. 5 and FIG. 6 both show the functioning of the encryption and decryption (for u=L_{E}) once using the two FP functions as independent components, and once with FP functions broken down into their components.

A further advantageous variant of the encryption method according to the invention described above, for example of the method E^{FP,EGen, OM, OM-NB}, consists of using the E-Raw encryption of a block cipher E of the block size L_{E}=u as a general cipher EGen, using a symmetric L_{E} bit-long key K, i.e. E^{RAW}_{K}.

By using E^{RAW}_{K} as EGen, the encryption Mc of a plaintext message M_{P}=PB₁∥PT^{OM}₁∥PT^{OM}₂∥AD consisting of PB₁, PT^{OM}₁, PT^{OM}₂, AD where L(PB₁)=L_{E} is defined depending on the two bit sequences ImpIAD and ImpIᵤ that implicitly do not belong to the message as follows:
E^{FP, E-Raw, OM, OM-NB}_{K}(PB1, PT^{OM}₁, PT^{OM}₂, AD, ImpIAD, ImpIᵤ):=CB₁∥E^{OM}_{K}(OM-NB(CB₁), PT^{OM}₁∥PT^{OM}₂)
   where CB₁:=E^{RAW}_{K}(FPᵤ(PB₁∥PT^{OM}₂∥AD∥ImpIAD)⊕(ImpIᵤ), and the decryption M_{P}′ of a ciphertext message M_{C}′=CB₁′∥CT^{OM}′∥AD′ consisting of CB₁′, CT^{OM}′, AD′ where L(CB₁′)=L_{E} is defined depending on L_{PT1} and the two bit sequences ImpIAD′ and ImpIᵤ′ that implicitly do not belong to the message as follows:

$${D}^{FP , D ‐ Raw , OM , OM ‐ {NB}_{K}} {CB}_{1}^{′} , {{CT}^{OM}}^{′} , {AD}^{′} , {L}_{PT 1} , {ImpIAD}^{′} , {Impl}_{u}^{′} ) := {FP}_{u}^{- 1} ( ( {D}^{R A {W}_{K}} ( {CB}_{1}^{′} ) ⊕ {Impl}_{u}^{′} ) ‖ {{PT}^{OM}}^{′} [ {L}_{PT 1} + 1 .. L ( P {{T}^{OM}}^{′} ) ] ‖ AD ‖ {ImpIAD}^{′} ) ‖ {{PT}^{OM}}^{′} where {{PT}^{OM}}^{′} := {D}^{O {M}_{K}} ( OM ‐ NB ( {{CB}_{1}^{u}}^{′} ) , {{CT}^{OM}}^{′} )$$

If a secure, key-dependent hash function HASH_{K_H}, e.g., a secure key derivation function using the key K_H, is used for any sufficiently large u as a basis for the Tagᵤ^{K_H} function of an FP function FP_{U}^{K_H}, then it is not possible for an attacker to determine the value Tagᵤ^{K_H}(BF) for a pre-determined bit sequence BF without knowing the key K_H. If, in addition, it is ensured that the bit sequence BF included in the computation of the value Tagᵤ^{K_H}(BF) is novel for each new message, then the value Tagᵤ^{K_H}(BF) for each new message computed using Tagᵤ^{K_H} is also novel. If these two conditions are fulfilled, then the u bit-long fingerprint, which results from the XOR operation of the u bit-long result of the application of a Scrambleᵤ function to the first u bits of the plaintext with the (novel and secret) value Tagᵤ^{K_H}(BF) that is also u bits-long, can be regarded as an encryption of the first u bits of the plaintext with the u bits-long novel key Tagᵤ^{K_H}(BF).

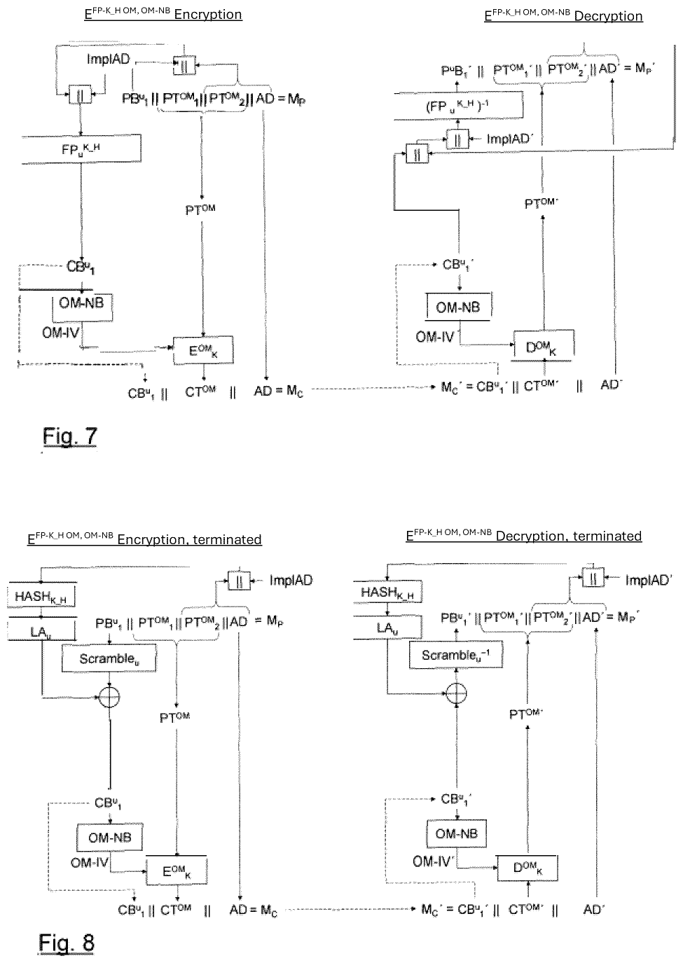

It is thus proposed, in order to ensure the novelty of the bit sequence included in the Tagᵤ function of the fingerprint function FPᵤ, to use a secure, key-dependent hash function HASH_{K_H} as a basis for the Tag_{U}^{K_H} function of an FP function FP_{U}^{K_H} for each new message, to dispense with the additional encryption of the first u bits of the plaintext by means of EGen, and instead to directly use the FP_{U}^{K_H} fingerprint as the encryption of the first u bits CB^{u}₁, and thus, for example, in the case of the above-described encryption method E^{FP, EGen, OM, OM-NB}, to use the value FPᵤ^{K_H}(PB^{u}₁∥PT^{OM}∥AD∥ImpIAD) as CB^{u}₁, i.e., CB^{u}₁:=FPᵤ^{K_H}(PB^{u}₁∥PT^{OM}₂∥AD∥ImpIAD). The encryption method derived from E^{FP, EGen, OM, OM-NB} in this manner is denoted by E^{FP-K_H, OM, OM-NB}. The following two FIGS. 7 and 8 show how such a method works. The use of the implicit value ImpIᵤ can be dispensed with here because the novelty of CB^{u}₁ has already been ensured by the novelty of (PT^{OM}₂∥AD∥ImpIAD). Note that when E^{FP-K_H, OM, OM-NB} is applied for the encryption of the first u bits, only the key K_H is used, and in particular the key K is not used. Note in addition that the method places no specific requirements on the Scrambleᵤ function of FPᵤ^{K_H}.

The proposed method makes a certain weak integrity check of the received message possible. The reason for this is that the hash value generated using the cryptographic hash function HASH_{(K_H)} is introduced into the encryption of the first plaintext block PB₁, and is “removed” from the latter again in the decryption. Each change to the encrypted message M_{C}′, i.e., the ciphertext CT′ or the additional data AD′, in particular regardless of the block in which this change took place, thus leads to a deviation of the first plaintext block PB₁′ obtained in the decryption from the original plaintext block PB₁ (which does not apply to the other parts of the message, in particular to other blocks of the ciphertext CT′ in this generalization). It is therefore proposed to design the format of the plaintext PT such that the first plaintext block PB₁ contains information which is as predictable as possible, i.e., information that contains little entropy, in particular obeys strong consistency rules, and which thus contains the maximum possible redundancy, so that the chance is increased that the receiver has a high probability of being able to recognize a change in the first plaintext block via consistency checks, for example when parsing the first plaintext block. If, after the decryption, the receiver determines that one of the consistency rules has been broken, then the receiver can recognize that the message M_{C}′ has been manipulated and can initiate exception handling if necessary. Examples of such redundancy-containing information could be the receiver identifier, the transmitter identifier, the protocol version used, etc.

In some operation modes, e.g., CBC, only complete plaintext blocks can be encrypted. If the last plaintext block is incomplete, then a padding method is used to pad it out. If padding is used and the plaintext is of a fixed length known to the transmitter and to the receiver, which is often the case for short, datagram-like messages, then it is proposed to include the unused padding bits, the number L_{pad} of which is equal for each plaintext in this case, at a fixed point in the first plaintext block PB₁, for example at its end, and accordingly to shift the rest of the plaintext by L_{pad} bits towards the end of the plaintext. In this manner, the last plaintext block becomes complete, no more padding is necessary, but the length of the encrypted plaintext CT does not change. It is further proposed to use the bits added to the first plaintext block PB₁ in this manner, in order to strengthen the authentication of the message, by allocating these L_{pad} bits a value PAD which can be checked by the receiver, for example a fixed value, for example a sequence of 0 bits, or a value that can be derived from the plaintext message, for example the last L_{pad} bits of the hash value-formed using HASH_{K_H}—of the original total plaintext message, i.e., of the total plaintext message without the included PAD bits. After the decryption, it can then be determined whether the value PAD′ of the bit sequence found at the known position in the decrypted message corresponds to the expected value PAD, which is known to the receiver or is derived from the decrypted message after the PAD′ bits are removed. If this is not the case, it can be assumed that the message has been manipulated.

A disadvantage of the proposed encryption method is that the first plaintext block is decrypted on the one hand only at the end of the decryption process, and thus the information contained within it can also only be used after the end of the total decryption process. On the other hand, this block must first be transmitted, because without it, it is not possible to decrypt the rest of the ciphertext. The information contained in the first transmitted plaintext block PB₁ can thus only be used after the decryption process has been completed, which can be a disadvantage, although it should not be considered a significant one due to the short messages targeted. In order to further minimize this disadvantage, the first block should, where possible, contain information that is not required during the decryption process. The selection of the information belonging to the first plaintext block is thus determined by the two requirements which are sometimes conflicting, the requirement of “minimal entropy” and the requirement of “non-urgent use”.

As indicated several times above, when using an initialization vector which might not be novel, the CBC operation mode is safer in many situations than, for example, the length-preserving CFB, OFB and CTR operation modes, because an initialization vector used repeatedly in the CBC operation mode generally does not lead to the disclosure of the ciphertext, which is for example the case in CTR in common configurations which occur often. Therefore, for the proposed method, which can increase the probability of the novelty of an initialization vector, but does not generally guarantee this, it is advisable to use CBC as an operation mode of the block cipher E. The significant disadvantage of the classic CBC operation mode, however, is that it can only encrypt entire blocks, meaning that incomplete blocks have to be completed by padding, which is not favorable to the length of the generated ciphertext, and thus the length of the message to be transmitted.

However, the CBC operation mode can be combined with the CTS mode (“Ciphertext Stealing”) in a known manner, whereby a ciphertext length equal to the plaintext length is also obtained when using the CBC operation mode. The CTS mode can only be applied to plaintexts that are longer than the block size of the block cipher E used, and which are thus longer than L_{E}. If the length of the plaintext PT to be encrypted is greater than L_{E}, then the encryption method described can be combined with the CBC CTS mode. By using CBC, the method described becomes robust against initialization vectors that might not be novel, and by using CTS, the length of the ciphertext does not exceed the length of the plaintext. It is thus proposed to use the CBC CTS operation mode as the operation mode OM in the method described.

In some situations, it is logical to encrypt the transmitted initialization vector, e.g., in order to make it more difficult for the attacker to analyze the intercepted messages. It is proposed to encrypt the first block CB₁ once again before the message Mc is sent, i.e., to send the message M_{CC}=CCB₁∥CT^{OM}∥AD instead of the message M_{C}=CB₁∥CT^{OM}∥AD, where CCB₁:=E^{RAW}_{K_IV} (CB₁) for a secret symmetric key K_IV of the bit length L_{E} known to both the transmitter and to the receiver. After the message M_{CC}′=CCB₁′∥CT^{OM}′∥AD′ is received, in the first step, the first block CCB₁′ is decrypted with K_IV, i.e.,
CB₁′:=D^{RAW}_{K_IV}(CCB₁′), and the message M_{C}′:=CB₁′∥CT^{OM}′∥AD′ is then decrypted according to the method described above.

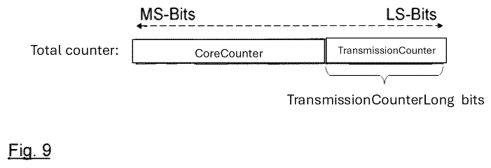

DE 10 2021 001 095 A1 proposes a counter-based method for recognizing short messages which have been cancelled and replayed and for protection from replay attacks. It is in particular proposed that the transmitter(S) and the receiver (E) should run a synchronized counter of a fixed bit length S.TotalCounter or E.TotalCounter to be incremented by one when each new message M is transmitted or received, and split this counter into two parts of fixed bit lengths, a core counter CoreCounter and a following transmission counter TransmissionCounter, so that S.TotalCounter=S.CoreCounter
∥S. TransmissionCounter and E. TotalCounter=E.CoreCounter∥E.TransmissionCounter, where the bit length of the TransmissionCounter is denoted by TransmissionCounterLength. It is further proposed to transmit only the TransmissionCounter part with each message M as M.TransmissionCounter, and to reconstruct the total counter E.TotalCounter on the receiver's side according to the method described in DE 10 2021 001 095 A1 from E.CoreCounter and M′.TransmissionCounter. (See FIG. 9)

If a certain part of the message M containing the M.TransmissionCounter needs to be encrypted, then it is logical, in order to get a novel initialization vector for each message but still save space in the message, to use the total counter S.TotalCounter to form the initialization vector, e.g., to derive a pseudo-random initialization vector from S.TotalCounter in a secure manner, for example by using the one block size-long value
S.IV:=LA (HASH_{(K_H)} (S. TotalCounter)) from the transmitter as an initialization vector for the encryption. If the transmitter transmits the S.TransmissionCounter as part of the message M, and thus as M.TransmissionCounter, the receiver can reconstruct the initialization vector used in the encryption after the message is received as E.IV:=LA(HASH_{(K_H)} (E.CoreCounter∥M′.TransmissionCounter)), because S.CoreCounter=E.CoreCounter is implicitly known to both sides. This approach only works, however, if M.TransmissionCounter is transmitted in plaintext. If, however, M.TransmissionCounter is to be transmitted encrypted, the conventional approach no longer works, because, in this case, the receiver cannot directly determine the value of the transmission counter from the message, in particular not before M′ has been decrypted.

In this case, the method proposed in this document can advantageously be used, because there is a high probability that the combination of the initialization vector with the first block of the plaintext to be encrypted is novel, M.TransmissionCounter is transmitted as part of the encrypted part of the message M, and yet a decryption of the ciphertext CT can still be carried out by the transmitter. For this purpose, S. TransmissionCounter is included in the first plaintext block PB₁ of the message M, which should always be possible because TransmissionCounterLength<L_{E} is always applicable in practice, and from the counter part S.CoreCounter=E.CoreCounter known to both sides, a pseudo-random value for S.ImpIᵤ is determined in a secure manner, e.g., with S.ImpIᵤ:=LA(HASH_{K_H} (S.CoreCounter)), which pseudo-random value forms a unique, in particular novel combination in combination with the first plaintext block PB₁ containing the S.TransmissionCounter. Finally, the message M is encrypted according to the proposed method with a symmetric key K using S.ImpI_{U}. The novelty of the total counter S.TotalCounter=S.CoreCounter∥S.TransmissionCounter guarantees that the combination of the value S.ImpIᵤ derived from S.CoreCounter and the first plaintext block PB₁ containing the counter part S.TransmissionCounter has a very high probability of being unique, and thus novel.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-17. (canceled)

18. A method for encrypting a plaintext using a block cipher E of the block size L_{E} using a symmetric key K, wherein the method comprises:
using a fingerprint function FPᵤ for encrypting the plain text that satisfies the two requirements that (1) from two different bit sequences BF1≠BF2, it follows with a sufficiently high probability for an intended application that results of the intended application of the fingerprint function FPᵤ to the two bit sequences are also different FPᵤ(BF1)≠FPᵤ(BF2), and (2) a fingerprint inverse function FPᵤ⁻¹ exists for the fingerprint function FPᵤ, such that the following always applies
FPᵤ⁻¹(FPᵤ (BF)∥BF[u+1 . . . L(BF)])=BF[1 . . . u],
wherein u and L_{E} need not necessarily be the same,
wherein a general cipher EGen is used by applying the fingerprint function FPᵤ to a concatenation of a complete first u bits PB^{u}₁ of the plaintext and of selected or of all bits FPInput of the remaining plaintext, and then computing a first block of ciphertext CB₁ by EGen encryption of the u bit-long result FPᵤ (PB^{u}₁∥FPInput) so that CB₁:=EGen(FPᵤ (PB^{u}₁∥FPInput)), and using the generated encryption of the first u bits of the plaintext CB₁ is as an initialization vector IV:=CB₁ to encrypt parts of or a total remaining plaintext with the block cipher E, for which purpose any operation mode requiring an initialization vector (IV) is used.

19. The method of claim 18, wherein a fingerprint function FP^{Tag_u, Scramble_u} (BF):=Scrambleᵤ (BF[1 . . . u])⊕Tagᵤ(BF[u+1 . . . L(BF)]) is used as the fingerprint function FPᵤ, where Tagᵤ is a function that computes, for bit sequences BF of any length, a value of the length u having a sufficiently high probability of being unique for the intended application, where Scrambleᵤ is an invertible function mapping bit sequences (BF) of length u to bit sequences BF of the length u, and where ⊕ represents a bitwise XOR operation of two bit sequences (BF) of the same length.

20. The method of claim 19, wherein a cryptographic hash function is used as the function Tagᵤ, of which the hash value is adapted to the length u in a secure manner.

21. The method of claim 20, wherein the function Tagᵤ has a property of non-invertibility or is collision-resistant in at least one way.

22. The method of claim 21, wherein a keyless or key-dependent cryptographic hash function HASH_{(K_H)} is used as the function Tagᵤ.

23. The method of claim 22, wherein
encryption Mc of a plaintext message M_{P}=PB^{u}₁∥PT^{OM}₁∥PT^{OM}₂∥AD consisting of PB^{u}₁, PT^{OM}₁, PT^{OM}₂, AD is defined depending on two implicit bit sequences ImpIAD and ImpIᵤ that do not belong to the plaintext message using a general length-preserving cipher EGen and a block cipher E as follows
E^{FP, EGen, OM, OM-NB}_{K}(PB^{u}₁, PT^{OM}₁, PT^{OM}₂, AD, ImpIAD,
ImpIᵤ):=CB^{u}₁∥E^{OM}_{K}(OM-NB(CB^{u}₁), PT^{OM}₁∥PT^{OM}2)
with CB^{u}₁:=EGen(FPᵤ(PB^{u}₁∥PT^{OM}₂∥AD∥ImpIAD)⊕ImpIᵤ), and
decryption M_{P}′ of a ciphertext message M_{C}′=CB^{u}1′∥CT^{OM}′∥AD′ consisting of CB^{u}₁′, CT^{OM}′, AD′ is defined depending on two implicit bit sequences ImpIAD′ and ImpIᵤ′ that do not belong to the message as follows
D^{FP, DGen, OM, OM-NB}_{K}(CB^{u}₁′, CT^{OM}′, AD′, L_{PT1}, ImpIAD′, ImpIᵤ′):=FPᵤ⁻¹ (DGen(CB^{u}₁′)⊕ImpIᵤ′)∥PT^{OM}′[L_{PT1}+1 . . . L(PT^{OM}′)]∥AD∥ImpIAD′)∥PT^{OM}′ with PT^{OM}′:=D^{OM}_{K}(OM-NB(CB^{u}₁′), CT^{OM}′).

24. The method of claim 18, wherein one of fingerprint functions FPᵤ^{HASH(K_H), ID} or FP^{HASH(K_H), E-K_S} is used as a fingerprint function FPᵤ in the encryption method.

25. The method of claim 18, wherein an E-Raw encryption of a block cipher E of block size L_{E}=u using a symmetric L_{E} bit-long key K, which is E^{RAW}_{K}, is used as a general cipher EGen in the encryption method.

26. The method of claim 23, wherein the encryption Mc of a plaintext message M_{P}=PB₁∥PT^{OM}₁∥PT^{OM}₂∥AD consisting of PB₁, PT^{OM}₁, PT^{OM}₂, AD, with L(PB₁)=L_{E}, is defined depending on the two implicit bit sequences ImpIAD and ImpIᵤ that do not belong to the message using a block cipher E having the block size L_{E}=u as follows
E^{FP, E-Raw, OM, OM-NB}_{K}(PB₁, PT^{OM}₁, PT^{OM}₂, AD, ImpIAD, ImpIᵤ):=CB₁∥E^{OM}_{K}(OM-NB(CB₁), PT^{OM}₁∥PT^{OM}₂)
with CB₁:=E^{RAW}_{K}(FP(PB₁∥PT^{OM}₂∥AD∥ImpIAD)⊕ImpIᵤ), and
the decryption M_{P}′ of a ciphertext message M_{C}′=CB₁′∥CT^{OM}′∥AD′ consisting of CB₁′, CT^{OM}′, AD′, with L(CB₁′)=L_{E}, is defined depending on L_{PT1} and the two implicit bit sequences ImpIAD′ and ImpIᵤ′ that do not belong to the message using a block cipher E having the block size L_{E}=u as follows
D^{FP, D-Raw, OM, OM-NB}_{K}(CB₁′, CT^{OM}′, AD′, L_{PT1}, ImpIAD′, ImpIᵤ′):=FP⁻¹((D^{RAW}_{K}(CB₁′)⊕ImpIᵤ′)∥PT^{OM}′[L_{PT1}+1 . . . L(PT^{OM}′)]∥AD∥ImpIAD′)∥PT^{OM}′ with PT^{OM}′:=D^{OM}_{K}(OM-NB(CB^{u}₁′), CT^{OM}′).

27. The method of claim 26, wherein a CBC operation mode is used as an operation mode OM, the padding of the blocks lying outside of the first block is dispensed with, and instead the CTS operation mode is applied in combination with the CBC operation mode.

28. The method of claim 23, wherein if L(CB₁)=L_{E}, the first block CB₁ is encrypted once again before the message M_{C} is sent.

29. A method for encrypting a plaintext PT with a block cipher E of the block size L_{E} using a symmetric key K, the method comprising:
using a fingerprint function FP^{Tag_u, Scramble_u} (BF):=Scrambleᵤ (BF[1 . . . u])⊕Tagᵤ(BF[u+1 . . . L(BF)]) as a fingerprint function (Fpu),ᵤ, where Tagᵤ is a function that computes, for bit sequences BF of any length, a value of a length u having a sufficiently high probability of being unique for an intended application, where Scrambleᵤ is an invertible function mapping bit sequences BF of the length u to bit sequences BF of the length u, and where ⊕ stands for a bitwise XOR operation of two bit sequences (BF) of the same length, and
wherein in order to ensure novelty of the bit sequence included in the Tagᵤ function of the fingerprint function FP^{Tag_u, Scramble_u}, a secure, key-dependent hash function HASH_{K_H} is used as a basis for the Tagᵤ^{K_H} function of a fingerprint function FPᵤ^{K_H} for each new message, additional encryption of first u bits of the plaintext by EGen is dispensed with and, instead the FPᵤ^{K_H} fingerprint is used directly as the encryption of the first u bits CB^{u}₁.

30. The method of claim 29, wherein a format of the plaintext PT is designed such that a first plaintext block PB₁ contains information that is as predictable as possible, in particular information having the maximum possible redundancy and adhering to strict consistency rules, it is checked whether the strict consistency rules have been complied with after the message is decrypted by the receiver and, if it is determined that one of the strict consistency rules has been broken, exception handling is initiated.

31. The method of claim 29, wherein an identity function or a length-preserving encryption function is used as a function Scrambleᵤ, wherein in a case of encryption, an appropriate decryption function for the encryption is used as an inverse function.

32. The method of claim 31, wherein for a block cipher E having a block size L_{E}=u and an L_{E} bit-long symmetric key K_S, the E_Raw encryption with K_S, so that E^{RAW}_{K_S} is used as the function Scrambleᵤ.

33. The method of claim 32, wherein a length of a initialization vector IV is adapted depending on the selected operation mode or depending on the length of CB₁.

34. The method of claim 29, wherein the plaintext is at least u+1 bits long.
